(19) United States
(12) Patent Application Publication
(10) Pub. No.: US 2026/0084300 A1
(43) Pub. Date: Mar. 26, 2026

(54) ROBOTIC MANIPULATOR AND SYSTEMS AND METHODS OF CONTROL

(71) Applicant: Honda Motor Co., Ltd., Tokyo (JP)

(72) Inventors: Sirui Chen, Stanford, CA (US); Rana Soltani Zarrin, Los Gatos, CA (US)

(21) Appl. No.: 19/330,181

(22) Filed: Sep. 16, 2025

Related U.S. Application Data
(60) Provisional application No. 63/697,289, filed on Sep. 20, 2024.

(51) Int. Cl. B25J 9/16; B25J 13/08

(52) U.S. Cl. CPC B25J 9/1633; B25J 13/084

(57) ABSTRACT

Systems and methods for improving dexterous and extrinsic manipulation of robotic manipulators in the presence of uncertain force readings from tactile sensors include a force estimator, a force planner, and a controller. These components employ algorithms that determine a range of safe operating configurations of the manipulator (e.g., positions and/or joint angles of fingers in a robotic hand) that result in stable manipulation of objects, even with the uncertainty of the tactile measurements.

### CROSS-REFERENCE TO RELATED APPLICATIONS

This application claims the benefit of Provisional Patent Application No. 63/697,289, filed Sep. 20, 2024, and titled “A Geometric Framework for Tactile Dexterous and Extrinsic Manipulation Under Force Uncertainty,” which is incorporated by reference herein in its entirety.

### BACKGROUND

In robotic manipulation, a long-standing challenge is enabling a robot to interact with and control objects in complex, unstructured environments. This involves two broad classes of behaviors: dexterous grasping, where the robot controls the object using only its own actuators (typically fingers or arms), and extrinsic manipulation, where the robot leverages external structures (e.g., walls, surfaces, or gravity) to aid in manipulating the object.

Dexterous manipulation and extrinsic grasping capabilities are essential for robots to function effectively in human-centered environments, such as helping with tasks that involve handling different objects or tools. Planning and control methods for such tasks that can enable robust and generalizable contact-rich manipulation need contact force information. While force sensors, particularly those capable of measuring six degrees of freedom, can provide accurate force readings for contact points on various kinds of manipulators (for example, robotic hands), such sensors are often infeasible for use in robotics due to various constraints. These sensors are typically expensive due to their mechanical and electrical complexity. They must provide high precision and resolution across multiple axes, often requiring finely tuned strain gauge arrays, low-noise signal conditioning, and careful mechanical design to achieve cross-axis decoupling. Additionally, such sensors demand extensive calibration procedures, often involving multi-axis force application and verification using precision equipment. The resulting components are ruggedized for industrial use and tailored to handle significant loads while maintaining accuracy, which further increases cost.

By contrast, tactile sensors are typically less expensive and are often used for measuring localized pressure or contact forces at or near the surface of a robotic gripper or manipulator. These sensors, which may use capacitive, resistive, or optical methods, are generally easier to manufacture using printed or flexible electronics, and do not require full six-axis decoupling or force vector resolution.

However, it is still quite challenging and expensive to develop tactile sensors that can provide accurate force readings, especially in both normal and shearing directions. While developing such tactile sensors is important, the ongoing research efforts in the field of dexterous manipulation require relying on the available tactile sensors with the aforementioned shortcomings.

There is a need in the art for a system and method that addresses the shortcomings discussed above.

### SUMMARY

Embodiments provided herein disclose methods and systems for improving dexterous and extrinsic manipulation with robotic manipulators in the presence of uncertain force readings from tactile sensors.

In some aspects, the techniques described herein relate to a robotic system, including: a robotic manipulator; a plurality of tactile sensors associated to at least one portion of the robotic manipulator; one or more processors to: receive contact force data from the plurality of tactile sensors; receive error information associated with errors in the contact force data; determine an estimated force using the contact force data; determine a target force using at least the error information; and use a difference between the estimated force and the target force to change a configuration of the robotic manipulator.

In some aspects, the techniques described herein relate to a control system for use with a robotic manipulator having a plurality of tactile sensors and a controller, including: one or more processors to: receive contact force data from the plurality of tactile sensors; receive error information associated with errors in the contact force data; determine an estimated force using the contact force data; determine a target force using at least the error information; and use a difference between the estimated force and the target force to determine a control signal for the controller.

In some aspects, the techniques described herein relate to a method for operating a robotic manipulator having a plurality of tactile sensors, the method including: receiving contact force data from the plurality of tactile sensors; receiving error information associated with errors in the contact force data; determining an estimated force using the contact force data; determining a target force using at least the error information; and using a difference between the estimated force and the target force to change a configuration of the robotic manipulator.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a robotic manipulator, according to an embodiment.

FIG. 2 is a schematic view of an exemplary architecture for the manipulation module shown in FIG. 1, according to an embodiment.

FIG. 3 is a schematic view of a process for adjusting a manipulator configuration based on information from tactile sensors, according to an embodiment.

FIG. 4A depicts a schematic view of an algorithm for determining an estimated force based on an observed force from one or more tactile sensors, according to an embodiment.

FIG. 4B depicts a schematic illustration of a model space associated with the algorithm of FIG. 4A, according to an embodiment.

FIG. 5A is a schematic view of a method of planning a target force based on information about errors in the tactile sensor data, according to an embodiment.

FIG. 5B is a schematic illustration of a model space associated with the algorithm of FIG. 5A, according to an embodiment.

FIG. 6 is a schematic view of a control loop architecture that may be implemented using the exemplary system, according to an embodiment.

### DETAILED DESCRIPTION

The embodiments may utilize any of the methods and systems as disclosed in the article “GeoDEx: A Unified Geometric Framework for Tactile Dexterous and Extrinsic Manipulation Under Force Uncertainty,” to Chen et al., which is included in the Appendix to the present application and herein incorporated by reference in its entirety and referred to as the “Geometric Framework for Manipulation Article”.

As discussed, a challenge in having robotic hands manipulate objects is obtaining sufficiently accurate force information from tactile sensors, which are more ubiquitous in robotic systems than specialized force and torque sensors. The embodiments provide systems and methods for improving dexterous and extrinsic manipulation in the presence of uncertain force readings from tactile sensors. In particular, rather than refine (e.g., filter) individual tactile sensor data in an attempt to obtain improved accuracy of force readings at individual contact points, the exemplary systems and methods employ algorithms that determine a range of “safe” operating configurations of the manipulator (e.g., positions and/or joint angles of fingers in a robotic hand) that result in stable manipulation of objects, even with the uncertainty of the tactile measurements. Moreover, the systems and methods may be used in cases of both dexterous manipulation and extrinsic manipulation.

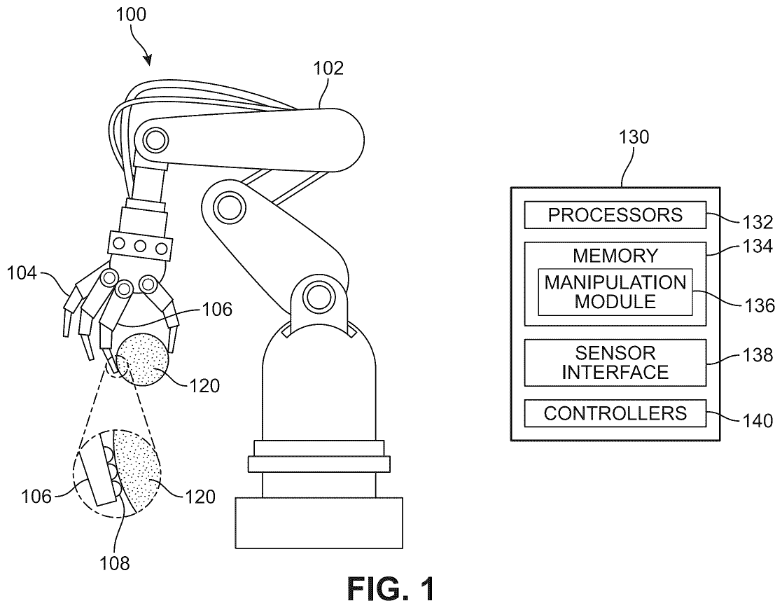

FIG. 1 is a schematic view of a robotic manipulator 100 (manipulator 100). As used herein, a “manipulator” in robotics refer to any mechanical device designed to interact with objects in its environment. These devices may comprise a series of interconnected segments or links, typically connected by joints that allow relative motion between adjacent links. Manipulators may be programmed to perform a wide range of tasks, from simple pick-and-place operations to complex assembly processes. Exemplary manipulators include robotic arms and robotic hands.

In FIG. 1, manipulator 100 has the form of an arm with a hand. Specifically, manipulator 100 comprises a multi-jointed arm 102 terminating in a hand-like end effector 104 equipped with multiple articulated digits or fingers 106. Such a configuration may allow for increased dexterity and versatility in object manipulation, potentially enabling the robot to grasp and manipulate objects of various shapes and sizes. For example, in FIG. 1, fingers 106 are shown grasping a ball 120.

In some embodiments, the fingers 106 may be equipped with sensors to provide feedback on grip strength and object properties, allowing for more precise control and adaptability in different task scenarios. In the embodiment of FIG. 1, manipulator 100 includes a plurality of tactile sensors that may be disposed on fingers 106 and/or other parts of manipulator 100. For example, in the enlarged focal view within FIG. 1, some sensors of a plurality of tactile sensors 108 are shown disposed on fingers 106 and in contact with a surface of ball 120.

Embodiments may use any suitable tactile sensors. Examples include tactile sensor arrays provided by Xela robotics, which are compact, deformable, and can provide 3D force direction and magnitude readings with contact locations. Other embodiments could utilize a flexible sensor array provided by Touchlab, which uses small piezoelectric sensor arrays to detect 1D force in the normal direction.

The general architecture of a manipulator may involve a combination of various types of motors, actuators, and control systems to enable precise and controlled movement of its components. In some implementations, the manipulator may utilize servo motors, stepper motors, or hydraulic actuators to drive the movement of its joints and links.

Servo motors may be employed in applications requiring precise position control and rapid response. These motors may incorporate built-in feedback mechanisms, such as encoders or potentiometers, to provide accurate position information. Stepper motors, on the other hand, may be used in situations where discrete, incremental movements are desired. These motors may offer high torque at low speeds and may be suitable for applications requiring precise positioning without the need for closed-loop feedback.

The control system for the manipulator may comprise several layers of hardware and software components. At the lowest level, motor drivers or amplifiers may be used to convert control signals into the appropriate voltage or current to drive the motors. These drivers may be capable of controlling motor speed, direction, and torque based on input from higher-level control systems. Microcontrollers or dedicated motion control processors may be employed to generate and coordinate the control signals for multiple motors. These devices may execute motion control algorithms, interpret sensor feedback, and implement safety features such as limit switches and emergency stops.

In some implementations, a higher-level control system, such as an industrial computer or programmable logic controller (PLC), may be used to manage overall manipulator operation. This system may handle task planning, coordinate multiple manipulators, interface with external sensors or vision systems, and provide a user interface for programming and monitoring.

The control logic for the manipulator may incorporate various algorithms and techniques to achieve smooth and accurate motion. These may include trajectory planning algorithms to generate optimal paths for the manipulator's end effector, inverse kinematics calculations to determine joint angles required to reach desired positions, and closed-loop control systems to maintain accuracy and compensate for external disturbances.

Manipulator 100 may be operated using hardware and software systems 130. In some cases, hardware and software systems 130 may be integrated with manipulator 100 in the form of onboard circuits, control units, or other suitable logical components. In other embodiments, hardware and software systems 130 may run on a separate computing system that receives tactile sensor information from manipulator 100 and sends control signals back to motors or other components of manipulator 100.

Systems 130 may be further comprised of processors 132 and memory 134. Systems 130 may also include a sensor interface 138 for receiving signals from tactile sensors 108. Systems 130 may also include one or more controllers 140 for sending control signals to motors or other components of manipulator 100 to move fingers 106 and/or portions of arm 102.

In some cases, systems 130 are operated to adjust the joint angles between different joints of fingers 106, hand 104, and/or arm 102. Moreover, control signals may be used to adjust not only the joint angles, but also the speed and force of the fingers 106 as they grasp various objects.

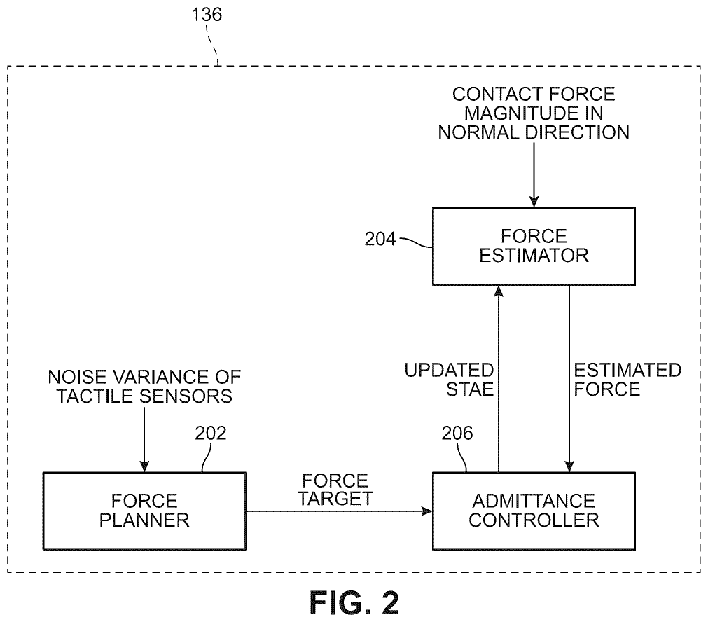

Systems 130 may further include manipulation module 136, which is stored in memory 134. Manipulation module 136 may comprise one or more algorithms for facilitating dexterous manipulation and extrinsic manipulation. An exemplary architecture for manipulation module 136 is shown in FIG. 2. This architecture may include a force planner 202, a force estimator 204, and an admittance controller 206. As discussed in further detail below, force planner 202 receives information related to the noise variance of the tactile sensors and plans a desired (or target) force trajectory.

Force estimator 204 receives information about the contact force applied at one or more tactile sensors in the normal direction, as well as a current state of the manipulator from admittance controller 206, and determines an estimated force. The target force and estimated force are delivered to admittance controller 206, which uses this information to determine how to control one or more fingers so as to facilitate dexterous manipulation or extrinsic manipulation.

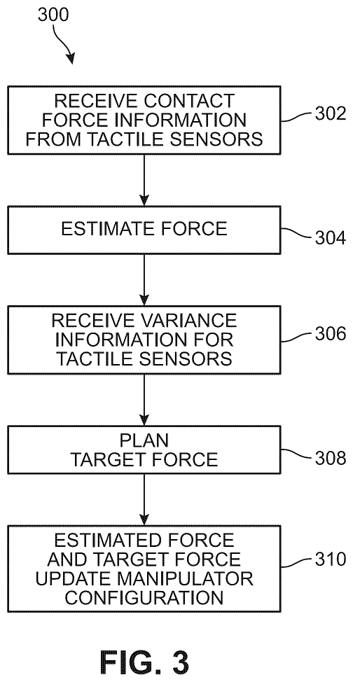

FIG. 3 is a schematic view of a process 300 for adjusting a manipulator configuration (e.g., changing the joint angles of at one or more joints of fingers 106) based on information from tactile sensors. In some cases, one or more of the steps of process 300 may be performed by hardware and software systems 130.

Starting in step 302, systems 130 may receive contact force information from one or more tactile sensors. In some cases, this includes normal force information. In some cases, raw signals received from tactile sensors may be converted to normal force data.

In step 304, systems 130 may estimate the force from the data gathered in step 302. Specifically, in some cases, force may be estimated by force estimator 204 of manipulation module 136. As discussed in further detail below, due to inherent noise in tactile sensor data and lack of force information outside of the normal direction, the force may be estimated using an algorithm that employs various assumptions about gravity, object acceleration, and other external forces.

In step 306, systems 130 may receive variance information for one or more tactile sensors. This variance information may be determined from observed measurement errors, synthetic data, and/or theoretical considerations. Based on the variance, systems 130 may plan a target (or desired) force in step 308. In some cases, this step may be performed by force planner 202 of manipulation module 136.

In step 310, systems 130 use both the estimated force and the target force to update the manipulator configuration. This may include sending one or more control signals to one or more motors or other components to actuate fingers 106 or other parts of manipulator 130 to perform dexterous grasping or extrinsic manipulation.

To accomplish force estimation and force planning under uncertainty in the force measurements from tactile sensors, the embodiments employ algorithms that map force measurements, as well as uncertainties in the measurements, to a subset of all possible forces that are compatible with various assumptions and goals. Specifically, the algorithms are constructed under the assumptions of quasistatic manipulation under gravity without other external forces, where the object is in force-equilibrium, and all contact forces cancel gravity at all times. Under these assumptions, measured forces (including both intrinsic and extrinsic) are considered as points in a measurement space referred to as the measurement cone (M-cone). Measured forces are then mapped to a subspace (a hyperplane) of all possible forces that may be applied by the manipulator. This subspace is referred to as the Force-Equilibrium (FE) plane and comprises all possible forces that act to balance the object's gravity. Given uncertainty in measurements, the system selects a target force in the FE-plane that is sufficiently close to the measurement (with errors) and which further satisfies various constraints (such as friction cone and minimum force constraints).

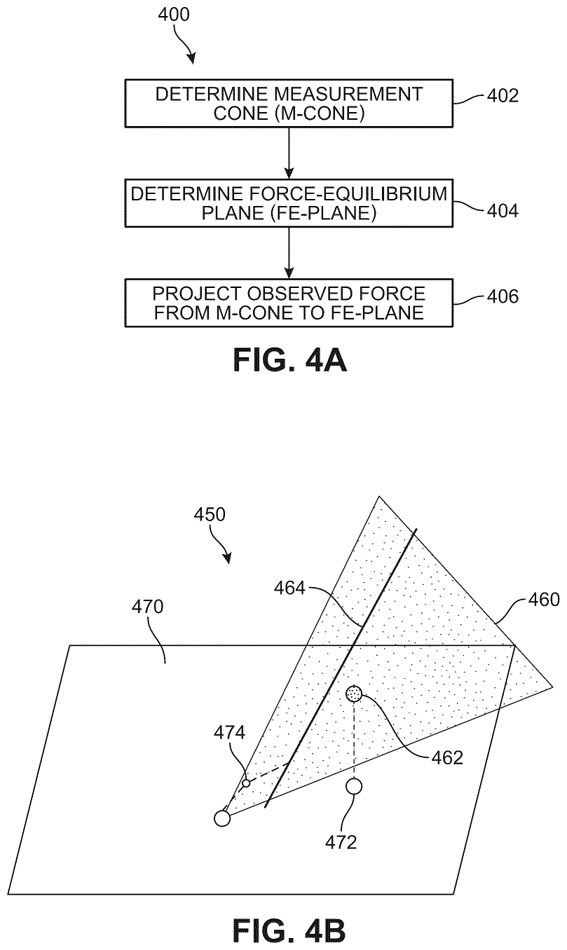

FIG. 4A depicts a schematic view of an algorithm 400 for determining an estimated force based on an observed (measured) force from one or more tactile sensors. FIG. 4B depicts a schematic illustration of a model space 450 to help visualize what is happening as part of algorithm 400. It may be understood that model space 450 may be a vector space whose points comprise vectors of contact forces. More specifically, given a set of contact points (including intrinsic and extrinsic contact points), contact forces for each point are stacked into a single vector within model space 450. The force equilibrium plane 470 comprises a hyperplane in model space 450 whose points correspond to a set of forces (with each force in the set of forces corresponding to a particular contact point) that balance the object's gravity.

In step 402 of FIG. 4A, a measurement cone in the model space is determined, comprising the set of all possible forces that may be measured at all possible contact points. In FIG. 4B, the measurement cone 460 is shown schematically as a triangle in the model space 450.

In step 404, the force-equilibrium plane is determined, comprising all possible forces that act to balance the object's gravity. In FIG. 4B, the force-equilibrium plane 470 is shown as a quadrilateral in the model space 450.

As seen in FIG. 4B, points in the measurement cone 460 may lie outside of the force equilibrium plane 470. Because the goal of the system is to apply contact forces to an object that keep the object in force equilibrium, it is desirable to find a corresponding point in the force equilibrium plane that is sufficiently close to a particular measurement point in the measurement cone.

In step 406, an algorithm may be used to project the observed force, which comprises a particular point in the measurement cone 460, onto a corresponding point in the force-equilibrium plane.

Depending on whether the system is performing dexterous grasping or extrinsic manipulation, the method by which the observed force is mapped onto the force-equilibrium plane may vary. For dexterous grasping, where all contact points are associated with tactile sensors, the measurement is one point of the measurement cone, and the projection is done using a projection operator to find the closest point on the force-equilibrium plane. In FIG. 4B, for example, the observed force 462 is mapped via a projection operator, onto an estimated force 472 in the force-equilibrium plane 470.

By contrast, for extrinsic manipulation, where some contact points don't have associated contact sensors, the observed force lies somewhere on a subspace of the measurement cone. This subspace comprises the set of all forces consistent with an observation made on the contact points having tactile sensor measurements. In this case, the estimated force is found by determining a point in the force-equilibrium plane that is closest to both the origin and the subspace cone. In some cases, this may be solved using quadratic programming. For example, in FIG. 4B, the observed force may be assumed to lie somewhere in the subspace 464 of the measurement cone 460 and the estimated force 474 is found using quadratic programming. Further details of the algorithms for finding the estimated force based on measurements in the cases for both dexterous grasping and extrinsic manipulation may be found in the Appendix to the present application.

Using the method of FIG. 4A, the system may above obtain a force measurement that is guaranteed to achieve force closure but may have errors compared to ground truth force. By incorporating information about the noise/errors in tactile sensor data, the system may bound the error. Specifically, in the context of the exemplary model space, such as model space 450 of FIG. 4B, the error may be bounded using an ellipsoid on the force-equilibrium FE-plane. Therefore, when planning forces for dexterous grasping or extrinsic manipulation, the system considers the potential error and makes a robust plan that remains feasible regardless.

As discussed, tactile sensors may have errors. For example, an exemplary tactile fingertip may comprise an array of 42 small 1D piezo-electric sensors (taxels) that are placed on the tip, body, and sides of the fingertip. The position of each taxel and its orientation (normal vector) relative to the fingertip base are known. The raw measurements from each taxel are the values provided by each taxel which represent the calibrated normal force reading of each taxel. Assuming point contact, the distributed forces on each fingertip can be represented by a single raw force located at the mean location of distributed forces, i.e. weighted average of taxel positions times their measured force. Similarly, the contact normal of each fingertip is the normalized weighted average of the normal vectors times their measured force. In some embodiments, taxels may have measurement errors in the range of 0.1 to 1 Newton per taxel (for example, for a taxel measuring between 0.1-20 N under full contact conditions), which can accumulate when computing the fingertip's raw force measurement. These errors may be due to factors such as the activation threshold, hysteresis, force error, and noise.

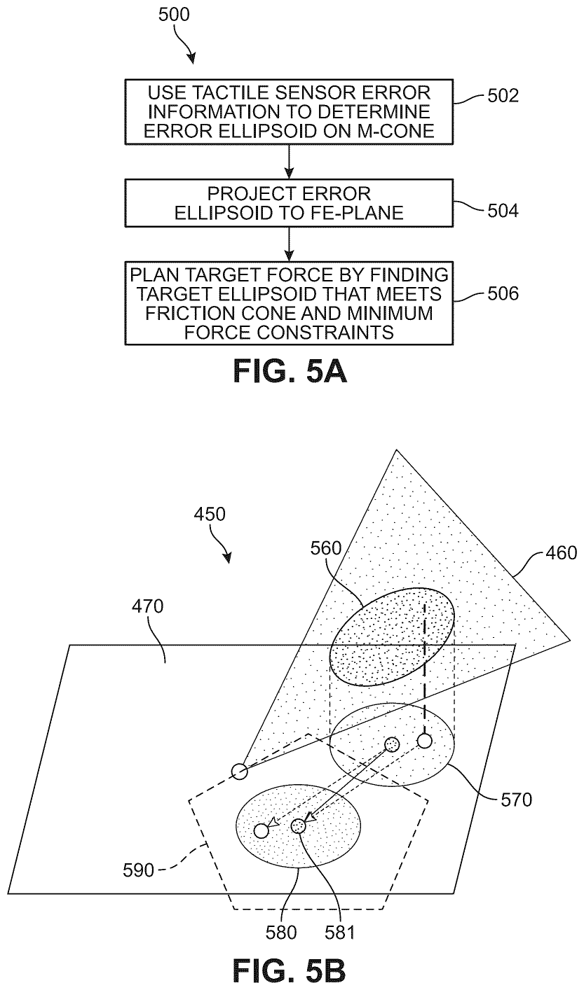

FIG. 5A is a schematic view of a method of planning a target force based on information about errors in the tactile sensor data. Starting in step 502, the tactile sensor error information is used to determine a measurement error ellipsoid on the measurement cone. In FIG. 5B, tactile sensor error information is used to generate a measurement error ellipsoid 560 on measurement cone 460.

In step 504, the error ellipsoid determined in step 502 is projected from the measurement cone to the force-equilibrium plane to yield a force error ellipsoid. For dexterous grasping, this may be done using the same projection operators as discussed above for FIG. 4A. As an example, in FIG. 5B, measurement error ellipsoid 560 may be projected to force error ellipsoid 570 on force-equilibrium plane 470. For extrinsic manipulation, rather than projecting an ellipsoid as in FIG. 5B, an elongated ellipsoid with infinite extent is generated and intersected with the force-equilibrium plane.

In step 506, the target force is planned by finding a center point within a target ellipsoid in the force-equilibrium plane, such that the boundary of the target ellipsoid stays within a constraint polygon in the force-equilibrium plane. The constraint polygon may be associated with friction cone and minimum force constraints that must be satisfied. In some cases, this may be accomplished using quadratic programming.

As an example, in FIG. 5B, a target force 581 of a target ellipsoid 580 is found whose boundary is contained entirely within a constraint polygon 590. Moreover, the target ellipsoid 580 may have the same geometric properties, including area, circumference, and/or other properties, as the force error ellipsoid 570.

For extrinsic manipulation rather than finding a center point for an ellipse completely contained within a constraint polygon, the algorithm may include finding a virtual center for an infinitely long ellipsoid such that the closest intersection of the ellipsoid to the origin always stays inside of the constraint polygon. In some cases, this may be accomplished using quadratic programming.

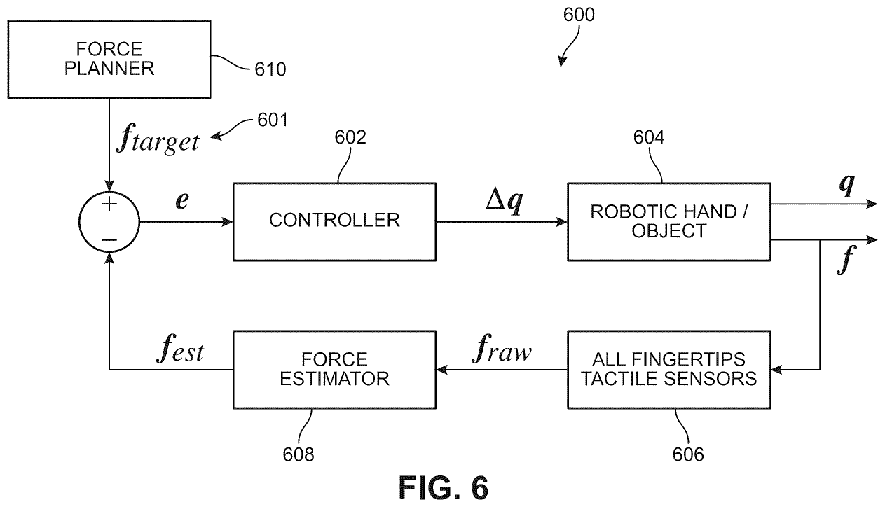

FIG. 6 is a schematic view of the control loop architecture 600 that may be implemented using the exemplary system. In this architecture 600, the hand-object environment 604 comprises the robotic hand and held object. A controller 602 sends control signals to change the joint positions of the robotic hand. These changed positions of the robotic hand joints affect the interaction forces between the fingertips and the object, and between the object and the environment. The state of the system may be given by the hand's joint angles q, the contact forces f, and the object's pose.

Raw force data (f_{raw}) from the fingertip tactile sensors 606, which measure intrinsic contact forces, may obtained. Due to the sensors'measurement errors, the raw force data is provided to force estimator 608 which generates an estimated force fₑₛₜ, using the methods described above. Considering the initial multi-finger grasp, the force planner 610 computes the initial contact locations and normals, and combines them with the object's properties to compute the desired force trajectory force f_{target}. The error e between the target (desired) forces and the observations at each contact point is used along with the fingertip's Jacobian to compute direction of motion of the fingertips as:

$$Δ q = {K}^{- 1} {J}^{T} ( q ) e$$

Here, K is a positive-definite gain matrix. The resultant change in joint angles (Δq) are used to update the desired joint angles of the robotic, which is realized through the hand's low-level PD controller.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example.

Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps.

However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A robotic system, comprising:
a robotic manipulator;
a plurality of tactile sensors associated to at least one portion of the robotic manipulator;
one or more processors to:
receive contact force data from the plurality of tactile sensors;
receive error information associated with errors in the contact force data;
determine an estimated force using the contact force data;
determine a target force using at least the error information; and
use a difference between the estimated force and the target force to change a configuration of the robotic manipulator.

2. The robotic system according to claim 1, wherein the one or more processors are configured to determine the estimated force by:
embedding the contact force data as a measured force within a measurement cone of a model space; and
projecting the measured force onto an estimated force within a force-equilibrium plane of the model space.

3. The robotic system according to claim 1, wherein the one or more processors are configured to determine the estimated force by:
determining a subspace cone within a measurement cone of a model space, the subspace cone being associated with the contact force data; and
finding an estimated force in a force-equilibrium plane of the model space such that the estimated force is closest to both an origin of the force-equilibrium plane and the subspace cone.

4. The robotic system according to claim 1, wherein the one or more processors are configured to determine the target force by:
determining an error ellipsoid using the error information;
projecting the error ellipsoid onto a projected ellipsoid in a force-equilibrium plane;
finding a center point for a target ellipsoid in the force-equilibrium plane such that the target ellipsoid has the same geometric properties as the projected ellipsoid and such that the target ellipsoid is contained within a constraint boundary in the force-equilibrium plane.

5. The robotic system according to claim 1, wherein the one or more processors are configured to determine the target force by:
determining an elongated ellipsoid in a force-equilibrium plane of a model space using the error information;
finding a virtual center for the elongated ellipsoid such that a closest intersection of the elongated ellipsoid with an origin of the force-equilibrium plane is contained within a constraint boundary in the force-equilibrium plane.

6. The robotic system according to claim 1, wherein the robotic manipulator is a robotic hand.

7. A control system for use with a robotic manipulator having a plurality of tactile sensors and a controller, comprising:
one or more processors to:
receive contact force data from the plurality of tactile sensors;
receive error information associated with errors in the contact force data;
determine an estimated force using the contact force data;
determine a target force using at least the error information; and
use a difference between the estimated force and the target force to determine a control signal for the controller.

8. The control system according to claim 7, wherein the one or more processors are configured to determine the estimated force by:
embedding the contact force data as a measured force within a measurement cone of a model space; and
projecting the measured force onto an estimated force within a force-equilibrium plane of the model space.

9. The control system according to claim 7, wherein the one or more processors are configured to determine the estimated force by:
determining a subspace cone within a measurement cone of a model space, the subspace cone being associated with the contact force data; and
finding an estimated force in a force-equilibrium plane of the model space such that the estimated force is closest to both an origin of the force-equilibrium plane and the subspace cone.

10. The control system according to claim 7, wherein the one or more processors are configured to determine the target force by:
determining an error ellipsoid using the error information;
projecting the error ellipsoid onto a projected ellipsoid in a force-equilibrium plane;
finding a center point for a target ellipsoid in a force-equilibrium plane such that the target ellipsoid has the same geometric properties as the projected ellipsoid and such that the target ellipsoid is contained within a constraint boundary in the force-equilibrium plane.

11. The control system according to claim 7, wherein the one or more processors are configured to determine the target force by:
determining an elongated ellipsoid in a force-equilibrium plane of a model space using the error information;
finding a virtual center for the elongated ellipsoid such that a closest intersection of the elongated ellipsoid with an origin of the force-equilibrium plane is contained within a constraint boundary in the force-equilibrium plane.

12. The control system according to claim 7, wherein the robotic manipulator is a robotic hand.

13. A method for operating a robotic manipulator having a plurality of tactile sensors, the method comprising:
receiving contact force data from the plurality of tactile sensors;
receiving error information associated with errors in the contact force data;
determining an estimated force using the contact force data;
determining a target force using at least the error information; and
using a difference between the estimated force and the target force to change a configuration of the robotic manipulator.

14. The method according to claim 13, wherein determining the estimated force further comprises:
embedding the contact force data as a measured force within a measurement cone of a model space; and
projecting the measured force onto an estimated force within a force-equilibrium plane of the model space.

15. The method according to claim 13, wherein determining the estimated force further comprises:
determining a subspace cone within a measurement cone of a model space, the subspace cone being associated with the contact force data; and
finding an estimated force in a force-equilibrium plane of the model space such that the estimated force is closest to both an origin of the force-equilibrium plane and the subspace cone.

16. The method according to claim 13, wherein determining the target force further comprises:
determining an error ellipsoid using the error information;
projecting the error ellipsoid onto a projected ellipsoid in a force-equilibrium plane;
finding a center point for a target ellipsoid in the force-equilibrium plane such that the target ellipsoid has the same geometric properties as the projected ellipsoid and such that the target ellipsoid is contained within a constraint boundary in the force-equilibrium plane.

17. The method according to claim 13, wherein determining the target force further comprises:
determining an elongated ellipsoid in a force-equilibrium plane of a model space using the error information;
finding a virtual center for the elongated ellipsoid such that a closest intersection of the elongated ellipsoid with an origin of the force-equilibrium plane is contained within a constraint boundary in the force-equilibrium plane.

18. The method according to claim 13, wherein the robotic manipulator is a robotic hand including fingertips.

19. The method according to claim 18, wherein using the estimated force and the target force to change a configuration of the robotic manipulator further comprises computing a direction of motion of the fingertips.

20. The method according to claim 19, wherein the method further comprises using the direction of motion of the fingertips to update one or more desired joint angles of the robotic hand by sending signals to a controller of the robotic hand.
